(19) United States
(12) Patent Application Publication
(10) Pub. No.: US 2010/0277866 A1
(43) Pub. Date: Nov. 4, 2010

(54) SERVER SYSTEM WITH SECURITY DEVICE AND METHOD OF CONTROLLING THEREOF

(75) Inventor: Ting-Kai CHEN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/499,099

(22) Filed: Jul. 8, 2009

(30) Foreign Application Priority Data
May 1, 2009 (TW) 98114654

(51) Int. Cl. G06F 1/16

(52) U.S. Cl. 361/679.57

(57) ABSTRACT

A sever system with security device is disclosed, which includes a server chassis having an opening, a blade server disposed in the server chassis, and an electronic lock disposed on the blade server and opposed to the opening. The blade server has a microprocessor, and the electronic lock is connected to the microprocessor. The electronic lock passes through the opening when the electronic lock is locked.

### RELATED APPLICATIONS

This application claims priority to Taiwan Application Serial Number 98114654, filed May 1, 2009, which is herein incorporated by reference.

### FIELD OF THE INVENTION

This invention relates generally to a blade server, and more particularly, to a blade server with a security device.

### BACKGROUND OF THE INVENTION

Currently, many enterprises install dozens or hundreds of relatively cheaper mini servers to satisfy network traffic requirements. In order to improve further economic effect, blade servers are developed. In regard to the blade server, it includes one or more processors, computer memory, and even hard drives integrated into a single motherboard. The machine case of a blade server can accommodate several tens of motherboard blades or more. Since the blade server can use the common resources such as the power supply, display, keyboard and so on, allowing effective integration into large data centers.

The blade server can support a hot-plug function, however, if a user is incautious or forces the blade server to be pulled out when the blade server is executing the program or the power is not off, the lifespan of the blade server is probably decreased or the information stored therein is probably lost. Therefore, it is important to find the ways to prevent the above situations.

### SUMMARY OF THE INVENTION

Accordingly, it is an aspect of the present invention to provide a server system with security device, thereby preventing the blade server from suffering damage due to forcing the blade server to be pulled out during operation.

According to an embodiment of the present invention, a server system with security device is provided, which includes a server chassis, a blade server and an electronic lock. The server chassis has an opening for receiving the blade server disposed therein. The blade server includes a microprocessor. The electronic lock is disposed on the blade server and opposed to the opening. The electronic lock is connected to the microprocessor. The electronic lock passes through the opening when the electronic lock is locked.

The blade server includes an operation panel, and the electronic lock is disposed on a side of the operation panel adjacent to the server chassis. The blade server may further include a plurality of light-emitting elements disposed on the operation panel. The server system with security device may further include a universal serial bus (USB) drive and a USB port disposed on the operation panel, in which the USB drive has a password that is stored therein and the same with a default password stored in the blade server. The blade server may include a baseboard management controller connected to the microprocessor. The server system with security device may further include a remote controlling device connected to the microprocessor that is connected to the baseboard management controller.

According to another embodiment of the present invention, a method of controlling server system with security device is provided. A system event is detected, the system event is classified into a locking event or a unlocking event, the system event is accomplished, and then an electronic lock disposed in a blade server is locked or unlocked. A first light sign is shown when the electronic lock is locked, and a second light sign is shown when the electronic lock is unlocked. A USB drive can be further inserted into a USB port of the blade server, and a password of the USB drive is compared with a default password, so as to unlock the electronic lock.

The server system with security device of the present invention utilizes the microprocessor in the blade server to determine the peripheral systemic information, so as to lock or unlock the electronic lock. The electronic lock can be controlled remotely by network connection. While an emergency occurs, the electronic lock can be unlocked by the specific USB drive. Therefore, the server system can effectively prevent the blade server from being pulling out from the server chassis when the blade server is executing the program or the power is turning on. In addition, the security device of the electronic lock can effectively prevent an invader from stealing the blade server without permission.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a diagram of a server system with security device according to an embodiment of the present invention.

FIG. 2 depicts a diagram of a server system with security device of FIG. 1 under locking situation.

FIG. 3 depicts a diagram of a server system with security device according to another embodiment of the present invention.

FIG. 4 depicts a block diagram of a server system with security device of FIG. 3.

FIG. 5 depicts a flowchart of a method of controlling a server system with security device according to another embodiment of the present invention.

FIG. 6 depicts a flowchart of an electronic lock controlled by a specific USB drive according to another embodiment of the present invention.

### DETAILED DESCRIPTION OF THE PREFERRED EMBODIMENT

Reference will now be made in detail to the present embodiments of the invention, examples of which are illustrated in the accompanying drawings. Wherever possible, the same reference numbers are used in the drawings and the description to refer to the same or like parts.

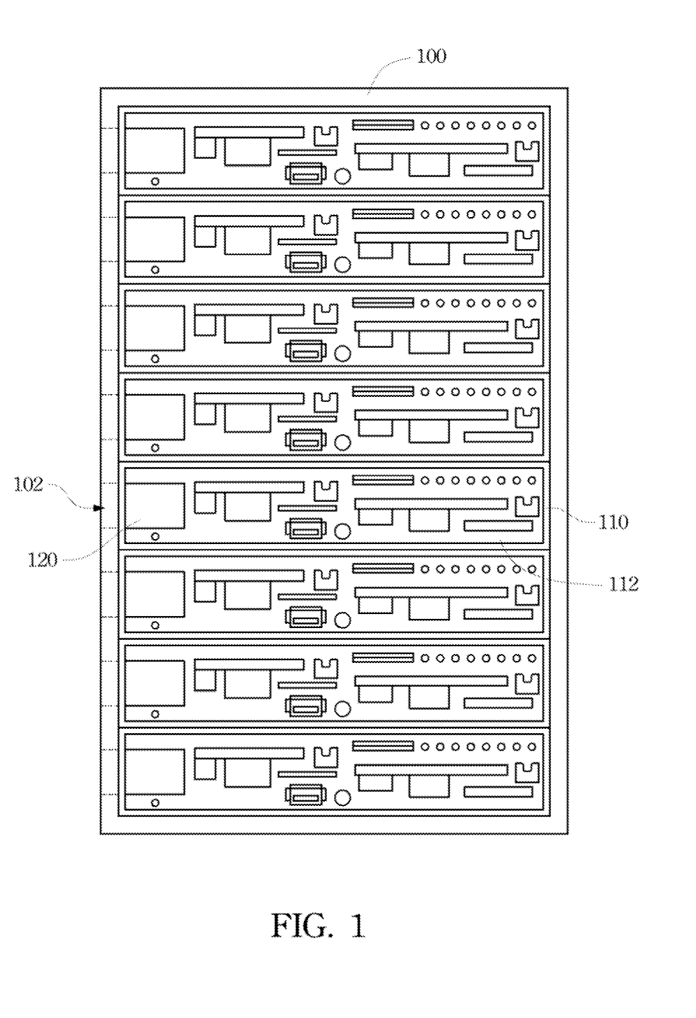

Reference is made to FIG. 1, which depicts a diagram of a server system with security device according to an embodiment of the present invention. The server chassis 100 may receive several blade servers 110, each including at least one electronic lock 120 disposed therein. The electronic lock is connected to the microprocessor and controls the electronic lock 120 to lock or unlock through the signal of the microprocessor.

The blade server 110 includes an operation panel 112 extending outwards from the server chassis 100, allowing a user to operate and observe that the blade server 110 operates normally or not. In this embodiment, the electronic lock 120 is disposed on the operation panel 112, especially on a side of the operation panel 112 adjacent to the server chassis 100. The sidewall of the server chassis 100 may have an opening 102 opposed to the electronic lock 120.

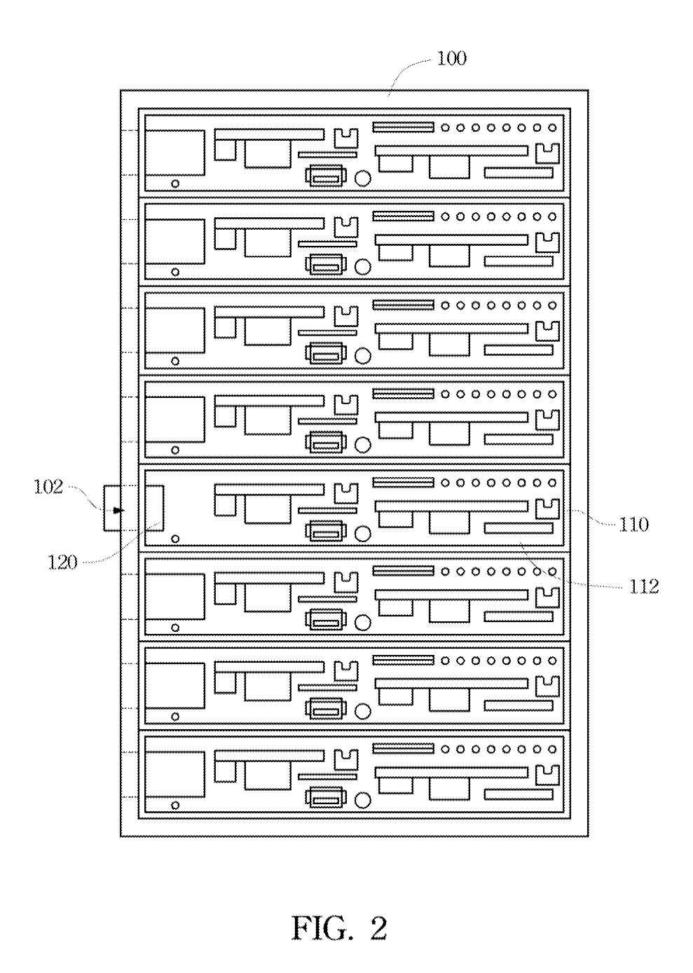

Reference is made to FIG. 2, which depicts a diagram of a server system with security device of FIG. 1 under locking situation. When the microprocessor sends a signal to turn on the electronic lock 120, the electronic lock 120 may extend outwards from the server chassis 100 and pass through the opening 102 of the server chassis 100. Meanwhile, the electronic lock 120 of the blade server 110 and the server chassis 100 are interlocked to each other, thereby preventing the blade server 110 from pulling out from the server chassis 100.

When the microprocessor sends another signal to unlock the electronic lock 120, the electronic lock 120 may return into the server chassis 100 from the opening 102 and recover the unlocked situation as shown in FIG. 1. At this time, the user can pull the blade server 110 out. Such setting of the security device can effectively prevent the user from mistaking to pull the blade server 110 out, as well as providing security that prevents an invader from stealing the blade server 110.

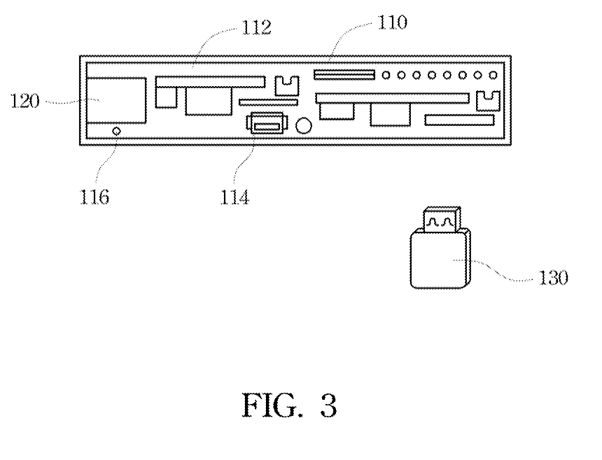

Reference is made to FIG. 3, which depicts a diagram of a server system with security device according to another embodiment of the present invention. The blade server 110 may further include a universal serial bus (USB) port 114, in which the USB port 114 is disposed on the operation panel 112 of the blade server 110. The blade server 110 may also include a specific USB drive 130, in which the USB drive 130 has a specific password that is stored therein and the same with the one stored in the blade server. When the user inserts the USB drive 130 into the USB port 114 of the blade server 110, the password of the USB drive 130 is compared and met with a default password, so as to unlock the electronic lock 120.

The blade server 110 may further include a plurality of light-emitting elements 116 disposed on the operation panel 112, for showing the locking or unlocking situations of the electronic lock 120. For example, when the blade server 110 has been closed normally, the electronic lock 120 can be unlocked, and the light-emitting elements 116 referring as unlocked can be lighted. Meanwhile, the blade server 110 and the baseboard connected to the server chassis 100 can be supplied with electricity continuously.

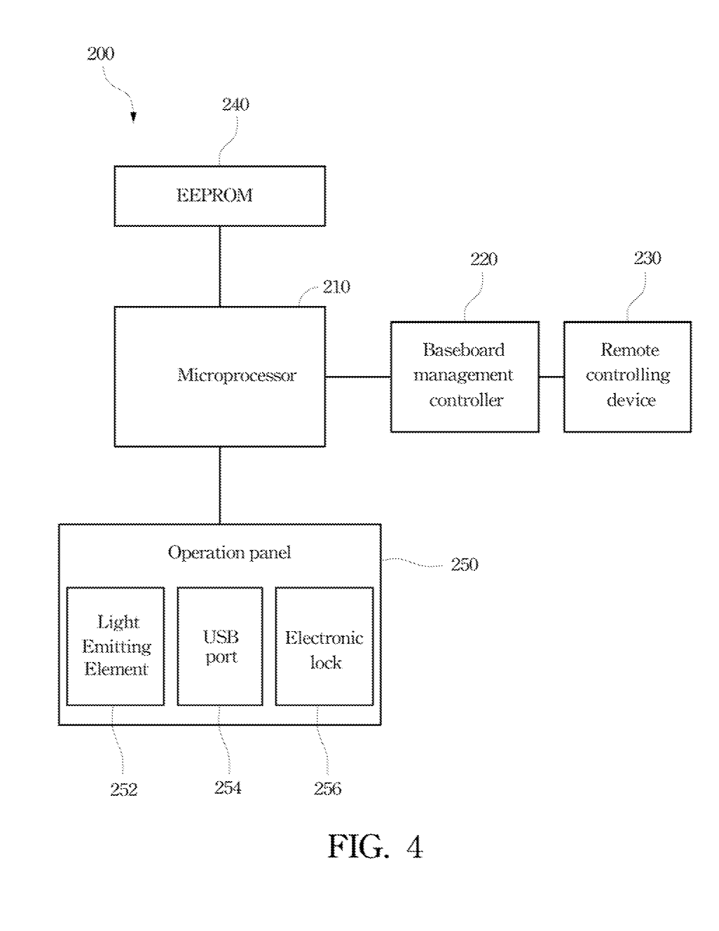

Reference is made to FIG. 4, which depicts a block diagram of a server system with security device of FIG. 3. The blade server 200 may include a microprocessor 210, a baseboard management controller (BMC) 220, a remote controlling device 230 connected to the BMC 220, an electrically erasable programmable read-only memory (EEPROM) 240, and an operation panel 250. The operation panel 250 may has a light-emitting element 252, a US port 254 and an electronic lock 256.

When the microprocessor 210 detects a current situation that cannot pull the blade server out, for example, a boosting situation, the microprocessor 210 can lock the electronic lock 256, preventing the user from mistaking to pull the blade server out. Optionally, the user can use a remote controlling device 230 through local networks, assisting with the BMC 220 and the microprocessor 210, the electronic lock 256 can be locked or unlocked via a remote controlling panel. Otherwise, when an emergency occurs and the electronic lock 256 must be unlocked, the user can insert the specific USB drive into the USB port of the blade server, and a password of the USB drive is compared with a default password stored in the EEPROM 240 by the microprocessor 210. When the two passwords are met with each other, the microprocessor 210 also can unlock the electronic lock 256.

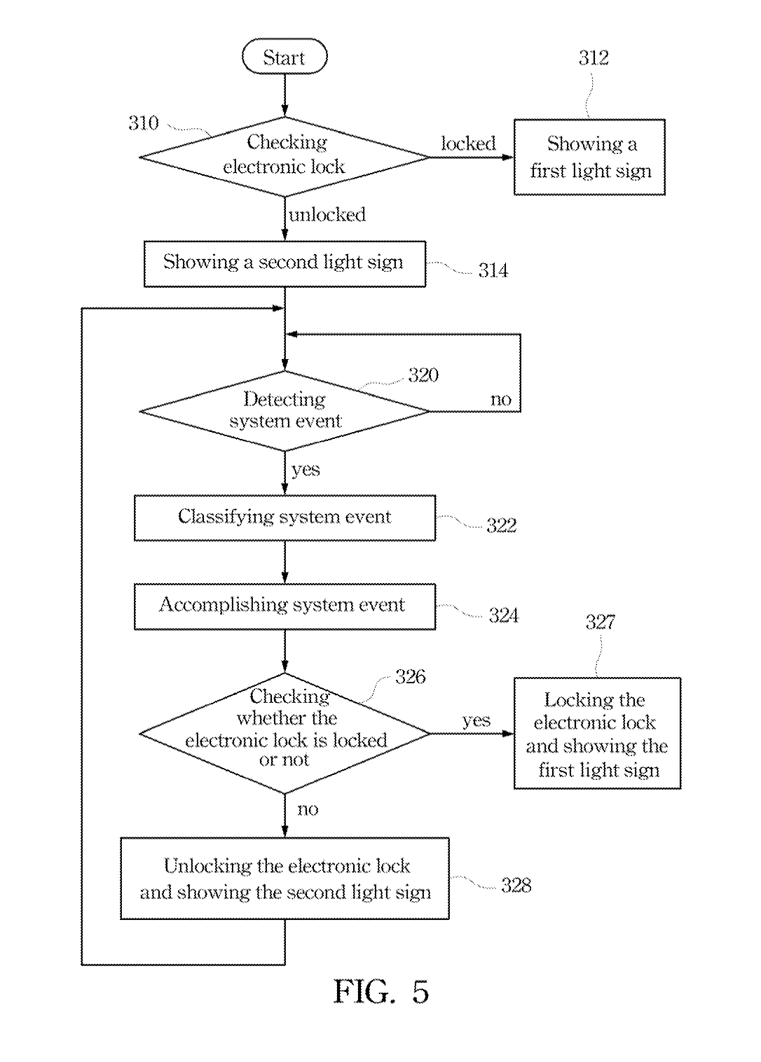

Reference is made to FIG. 5, which depicts a flowchart of a method of controlling a server system with security device according to another embodiment of the present invention. In the step 310, the electronic lock is checked whether it is locked or not. When the electronic is locked, the step 312 it proceeds, in which the first light sign is shown for announcing the user that the electronic lock is locked, and meanwhile, the blade server cannot be directly pulled out from the server chassis. When the electronic lock is checked that it is unlocked in the step 310, the step 314 proceeds, in which the second light sign is shown for announcing the user that the electronic lock is unlocked. The first light sign and the second light sign can be shown by light-emitting elements, for example, the first light sign may be a red light, and the second light may be a green light.

Next, in the step 320, the microprocessor continuously detects whether a system event enters or not. When a system event is detected, the system event is classified to a locking event or unlocking event in the step 322, so as to decide whether the electronic lock is locked or unlocked after the system event is accomplished. For example, the system event can be a power event, a thermal event, a server plug event, a remote controlling event, a USB drive comparison event and so on. Those events are classified in the step 322, so as to decide the corresponding situations after the event is accomplished.

Following, in the step 324, the system event is accomplished. After the system event is accomplished, the step 314 proceeds to check whether the electronic lock is locked or unlocked. When the electronic lock is decided to lock in the step 326, the step 327 proceeds to lock the electronic lock and to show the first light sign. When the electronic lock is decided to unlock in the step 326, the step 327 proceeds to unlock the electronic lock and to show the second light sign.

Various system events as aforementioned can be arranged in priority according to the user setting. For example, given that the USB drive-unlocking event is set in a top priority, when the specific USB drive inserts into the blade server, the passwords are compared and matched, and the electronic lock must be unlocked even when the blade server is boosting.

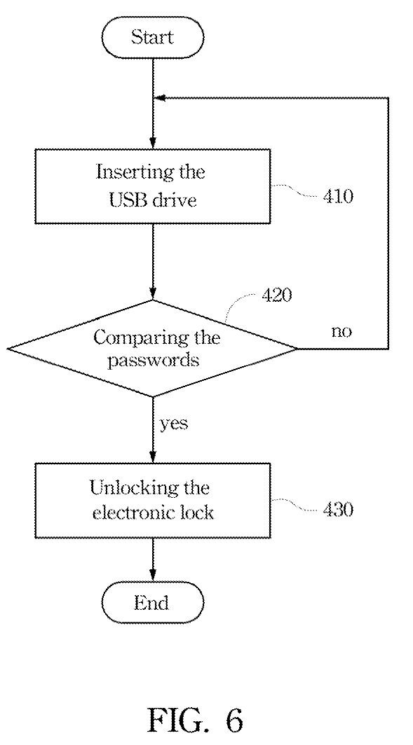

Reference is made to FIG. 6, which depicts a flowchart of an electronic lock controlled by a specific USB drive according to another embodiment of the present invention. In the step 410, the USB drive is inserted into the blade server. Next, in the step 420, a password stored in the USB drive is compared with a default password stored in the EEPROM of the server system. When two passwords are met with each other, the electronic lock can be unlocked in the step 430. This embodiment is suitable for directly unlocking the electronic lock of the blade server by using the USB drive under an emergency.

According to the embodiments of the present invention, the present invention beneficially provides a server system with security device that utilizes the microprocessor in the blade server to determine the peripheral systemic information, so as to lock or unlock the electronic lock. The electronic lock can be controlled remotely by network connection. While an emergency occurs, the electronic lock can be unlocked by the specific USB drive. Therefore, the server system can effectively prevent the blade server from being pulling out from the server chassis when the blade server is executing the program or the power is turning on. In addition, the security device of the electronic lock can effectively prevent an invader from stealing the blade server without permission.

As is understood by a person skilled in the art, the foregoing embodiment of the present invention is illustrated of the present invention rather than limiting of the present invention. It is intended to cover various modifications and similar arrangements included within the spirit and scope of the appended claims. Therefore, the scope of which should be accorded to the broadest interpretation so as to encompass all such modifications and similar structure.

What is claimed is:

1. A server system with security device, comprising:
a server chassis having an opening;
a blade server disposed in the server chassis, wherein the blade server comprises a microprocessor; and
an electronic lock disposed in the server chassis, opposed to the opening, and connected to the microprocessor, wherein the electronic lock passes through the opening when the electronic lock is locked.

2. The server system with security device according to claim 1, wherein the blade server comprises an operation panel, and the electronic lock is disposed on a side of the operation panel adjacent to the server chassis.

3. The server system with security device according to claim 2, wherein the blade server comprises a plurality of light-emitting elements disposed on the operation panel.

4. The server system with security device according to claim 2, further comprising:
a universal serial bus (USB) drive, wherein the USB drive has a password that is stored therein and the same with the one stored in the blade server; and
a USB port disposed on the operation panel.

5. The server system with security device according to claim 1, further comprising:
a baseboard management controller connected to the microprocessor.

6. The server system with security device according to claim 5, further comprising:
a remote controlling device connected to the microprocessor connected to the baseboard management controller.

7. A method of controlling server system with security device, comprising:
detecting a system, event;
classifying the system event into a locking event or a unlocking event;
accomplishing the system event; and
locking or unlocking an electronic lock disposed in a blade server.

8. The method of controlling server system with security device according to claim 7, wherein a first light sign is shown when the electronic lock is locked.

9. The method of controlling server system with security device according to claim 7, wherein a second light sign is shown when the electronic lock is unlocked.

10. The method of controlling server system with security device according to claim 7, further comprising:
inserting a USB drive into a USB port of the server system and comparing a password of the USB drive with a default password of the server system, so as to unlock the electronic lock.
